(19) United States
(12) Patent Application Publication
(10) Pub. No.: US 2017/0042136 A1
(43) Pub. Date: Feb. 16, 2017

(54) Underwater Video Recorder Assembly

(71) Applicant: Louis Charles Anderson, College Station, TX (US)

(72) Inventor: Louis Charles Anderson, College Station, TX (US)

(21) Appl. No.: 15/233,551

(22) Filed: Aug. 10, 2016

Related U.S. Application Data
(60) Provisional application No. 62/205,701, filed on Aug. 15, 2015.

(51) Int. Cl. A01K 97/00; H04N 5/232; H04N 5/225; H04N 5/77; A01K 85/00; H04N 7/18

(52) U.S. Cl. CPC A01K 97/00; A01K 85/00; H04N 7/188; H04N 5/2252; H04N 5/772; H04N 5/23241

(57) ABSTRACT

The present invention is directed to possible configurations of an underwater digital video recorder/camera (DVR/C) with remote start recording (or taking pictures) when a fish bites the bait or artificial lure. The device and associated methods for capturing and storing video and/or images of fish after it bites the bait or lure are described. The DVR/C devices may be in the form of an in-line device, a fishing lure or other potential configurations. The DVR/C device will start recording and continually capture underwater video from when it starts until turned off or the battery is discharged. Additionally, while fishing the digital video camera/recorder can store the video in memory or in micro SD cards when the system is turned on (recording) for subsequent review by the angler.

### CROSS-REFERENCE TO RELATED APPLICATIONS

This application claims priority to provisional U.S. patent application Ser. No. 62/205, 701 filed Aug. 15, 2015 the entire contents of which is hereby expressly incorporated by reference thereto.

### BACKGROUND OF THE INVENTION

1. Field of the Invention

The present invention relates to a miniature digital video recorder/camera (DVR/C) that is used in conjunction with a fishing line or a fishing lure to record the behavior of fish as the fish is hooked or approaching the bait. This information is useful for entertainment, educational and biological study purposes.

2. Description of Related Arts Invention

Digital video recorder/cameras have been incorporated into fishing lures for purposes of recording videos and pictures while fishing as the fish approach the lure. See for example US patent publication number 2012/0047790 A1. A camera 28 is positioned within body 14 which is in the shape of a fishing lure. Control buttons 50 control operation of the camera. A similar device is disclosed in US publication number 2013/0107031 A1.

In the prior art, battery power is a limiting commodity. Typically the recorder/camera is energized above water before the device is lowered to a fishing position. Thus, a great deal of battery life is wasted while there is no activity at the submerged camera.

Consequently there is a need for a mechanism that would turn on the power only when needed, that is when a fish is hooked or in the process of nibbling at the bait.

### BRIEF SUMMARY OF THE INVENTION

These and other needs in the art are met by the inclusion of an on/off switch for the battery power for the video recorder/camera that is activated by the movement of the fishing line to which the bait or fishing lure is attached. Additionally the switch must be triggered without having any mechanical connection between the video recorder/camera and the water. A Reed switch or Hall Effect transistor for example is incorporated into the circuitry and is responsive to a moveable magnet.

The magnet is attached to a portion of the fishing line so that as the fish is hooked and takes the bait, the magnet will be drawn away from the switch so as to start the power to the camera.

The present invention provides various embodiments of underwater DVR/C devices and methods for capturing and storing videos and images of fish hooked on the fishing line. The System can be set up to start recording after the fish bites the lure or bait until it is landed or the system may also be set to operate to record all data before starting to fish and until it is turned off. The DVR/C device may be in the form of an in-line device, a fishing lure or other configuration. The DVR/C captured underwater video or images are stored on a MicroSD memory card or other memory with the DVR/C for later review and editing by the angler. The video files may be viewed by a connection with a personal computer (PC), personal digital assistant (PDA) or other similar type device. Additionally the system may be used to survey underway animals, plants and bottom structures. These videos may be used for various scientific purposes, video for personal records and for sporting fishing videos for public viewing on YouTube, television or other public situations.

### BRIEF DESCRIPTION OF SEVERAL VIEWS OF THE DRAWINGS

For a detailed description of the preferred embodiments of the invention, reference will now be made to the accompanying drawings in which:

FIG. 1 is an embodiment of a schematic of the DVR/C system water tight enclosure and the magnet holder.

FIG. 2 is an embodiment of a block diagram of the DVR/C system with DVR/C, recording memory (media), battery and magnetic switch.

FIG. 3 is an embodiment of a schematic of the water tight enclosure connected with fishing equipment and showing how the magnetic switch is triggered.

FIG. 4 is an embodiment of a schematic of the water tight enclosure inside a fishing lure.

FIG. 5 is a perspective view of a mounting arrangement embodiment for the DVR/C assembly.

### DETAILED DESCRIPTION OF THE INVENTION

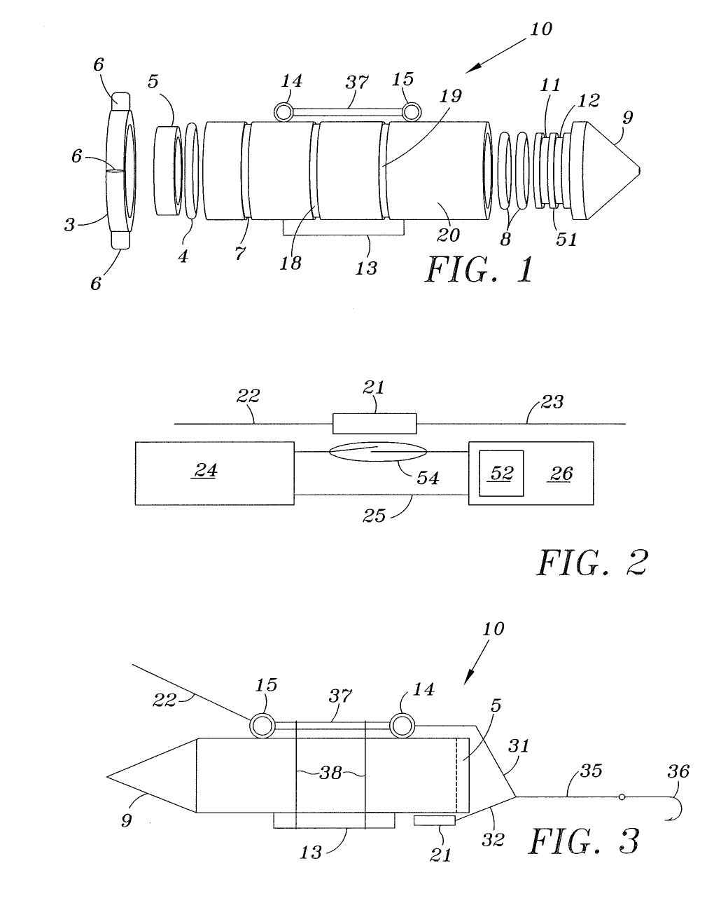

As shown in FIG. 1, the water tight container 10 for the DVR/C includes a central cylindrical portion 20 having a plurality of annular grooves 7, 18, and 19. At one end of the cylinder a cone shaped cap 9 has an inwardly extending portion 51 with a plurality of grooves 11, 12 which are adapted to receive O-rings 8 that will form a tight seal within cylindrical member 20.

At another end of the cylindrical housing 20 a window 5 is secured within the container by glue for example and may be made of plastic.

An annular collar 3 with fins 6 rests over O-ring 4 and can be removably positioned around cylindrical housing 20 for stabilization.

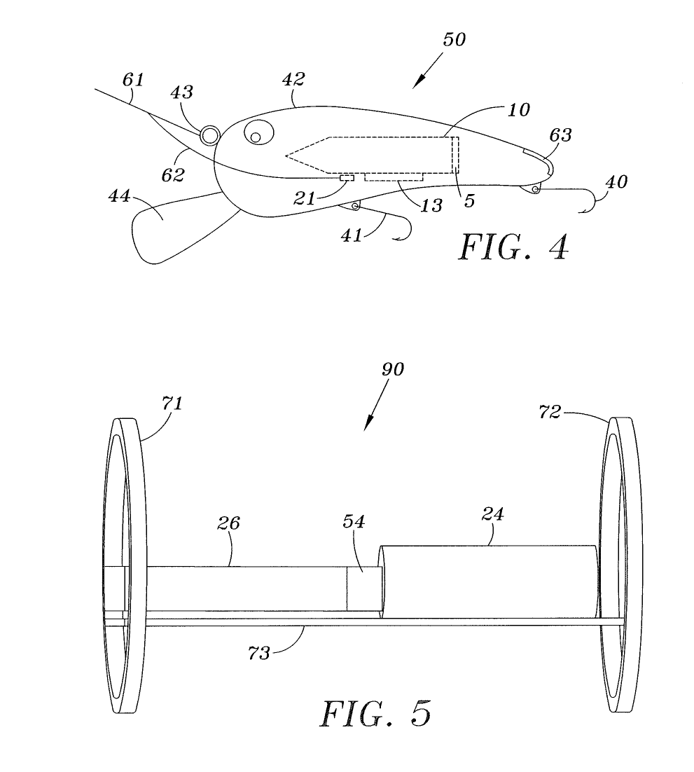

Container 10 includes eyelets 14 and 15 for connection to a fishing line and a lure line as shown in FIG. 3. Eyelets 14 and 15 may be connected together by a rod 37. Container 10 may be made of plastic or metal or a combination of both. O-ring 4 is positioned within groove 7 and is designed to allow collar 3 to breaks free of the container.

Magnet housing 13 and eyelets 14 and 15 with rod 37 may be attached to container 10 by glue or wire or fishing line 38 around grooves 18 and 19 as shown in FIG. 3.

FIG. 2 illustrates an embodiment of a schematic of the electrical components housed within container 10. A battery 24 is connected to DVR/C 26 which includes a micro SD card 52. A Reed switch 54 which is positioned between the battery and DVR/C is normally held in the open position by a movable magnet 21 when positioned above the switch as shown. Other types of Reed switches that are normally in a closed position or other types of switches that can be activated by movement of a magnet or other switches that are remotely actuated that are known in the art may also be used. Also a normally closed Reed switch can be used in conjunction with a NAND gate or a comparator in a circuit built into the camera. Magnet 21 in this embodiment may be attached at one end to the fishing line and at the other to the bait line so that movement of the fishing line will move magnet 21 away from Reed switch 54 thus starting the power to the circuit. The fishing and bait lines can pass through a tubular that is attached to container 10.

The DVR/C can be a DVR with resolution of 480 p, 720 p or 108 p or other DVR/C as they become available. This set up will allow for easy change of cameras to upgrade the system without needing to have a new system. The memory where the video or pictures are stored are typically Micro SD cards, but can also be on board memory, SD cards and other memory types that might be integrated into the DVR/C in the future. The batteries may be integrated in to the camera and are rechargeable by USB or other connections. The battery may also be removable and interchangeable. The switch shown is a Reed switch, but could also be a Hall Effect transistor depending on the camera used.

As shown in FIG. 3, the fishing pole line 22 is attached to eyelet 15 and the lure 31, 35 with hook 36 is attached to eyelet 14. A second line 32 is attached at one end to a magnet 21 which is normally located within magnet housing 13 above Reed switch 54 which is within container 10 along with battery 24 and DVR/C 26. The other end of line 32 is attached to lure line 31, 35 in such a manner that as the fish is hooked, magnet 21 will be pulled from magnet housing 13 so as to close Reed switch 54 and provide power to the DVR/C. Magnet 21 is in close sliding relationship with housing 13 such that a slight force is required to remove the magnet from the housing.

Magnet housing 13 can be glued to cylindrical housing 20 or secured thereto by wires 38 that surround housing 20. DVR/C is positioned within the container 10 such that the camera lens faces window 5 as shown in FIG. 3. Thus the camera is facing line 35 of baited hook 36. The magnet as an alternative could be reversed to connect to the fishing line going to the rod and reel.

FIG. 4 illustrates another embodiment of the invention in which the DVR/C and container 10 is incorporated into the body 42 of a fishing lure 50. The lure includes a plurality of fishing hooks 40, 41, and an eyelet 43 to which a fishing line 61 is attached. A second line 62 is attached to fishing line 61 at one end and to magnet 21 so that as a fish is hooked line 62 will remove magnet 21 from holder 13 to close Reed switch 54 thereby providing power to DVR/C 26. In this embodiment window 5 is facing a transparent portion 63 of the fishing lure. Lure 50 includes a stabilizing fin 44.

FIG. 5 illustrates an embodiment of a support for the camera assembly and battery within cylindrical housing 20.

A pair of ring member 71, 72 which have an outside diameter approximately equal to the inside diameter of housing 50 are connected to a planar mounting plate 73 which extends to two points on the circumference of the rings. DVR/C 26, Reed switch 54 and battery 24 can be releasably mounted on plate 74 so as to be easily replaceable by removing end piece 9 and mounting assembly 90.

Although the present invention and its advantages have been described in detail, it should be understood that various changes, substitutions and alterations may be made herein without departing from the spirit and scope of the invention as defined by the appended claims.

What is claimed is:

1. A digital video recorder camera assembly for underwater observation of fish comprising;
a) a digital video recorder/camera,
b) a water tight container for housing the digital video recorder camera,
c) a power source,
d) a window sealed to the water tight container, and
e) a switch triggered by movement of a fishing line or lure to provide power to the DVR/C.

2. The digital video recorder/camera assembly of claim 1 wherein the switch is a Reed switch or Hall Effect transistor triggered by a magnet.

3. The digital video recorder/camera assembly of claim 2 wherein movement of the fishing line or lure causes the magnet to move away from the Reed switch thereby triggering the switch.

4. The digital video recorder camera assembly of claim 1 wherein the water tight container is embedded in a fishing lure having a transparent portion.

5. The digital video recorder/camera assembly of claim 1 further including a SD card.

6. A digital video recorder/camera assembly as claimed in claim 1 further including a pair of eyelets for connection to a fishing line and a bait line.

7. A digital video recorder/camera assembly as claimed in claim 4 wherein the fishing lure includes at least one bait hook.

8. A fishing tackle device, comprising: a water-tight container with eyelets connected to the container, the eyelets configured for connection to fishing line to the rod and reel and to either a lure or baited hook; a digital video recorder/camera (DVR/C); and a magnetic switch and magnet to remotely start the DVR/C.

9. The fishing tackle device of claim 9 wherein the device is embedded in a fishing lure.
